(19) United States
(12) Patent Application Publication
(10) Pub. No.: US 2015/0261186 A1
(43) Pub. Date: Sep. 17, 2015

(54) DIGITAL HOLOGRAPHIC IMAGE RECORDING METHOD AND SYSTEM BASED ON HIERARCHICAL HOGEL

(71) Applicant: Electronics and Telecommunications Research Institute, Daejeon (KR)

(72) Inventors: Kwan Jung OH, Daejeon (KR); Bong Ho LEE, Daejeon (KR); Tae One KIM, Daejeon (KR); Hyon Gon CHOO, Daejeon (KR); Jae Han KIM, Gwacheon-si Gyeonggi-do (KR); Kyung Ae MOON, Daejeon (KR); Jin Woong KIM, Daejeon (KR)

(21) Appl. No.: 14/656,876

(22) Filed: Mar. 13, 2015

(30) Foreign Application Priority Data
Mar. 14, 2014 (KR) 10-2014-0030339

(51) Int. Cl. G03H 1/30; G03H 1/04; G03H 1/22

(52) U.S. Cl. CPC G03H 1/30; G03H 1/2294; G03H 1/0443; G03H 1/0476; G03H 2225/30; G03H 2225/35; G03H 2001/0452; G03H 2001/0478

(57) ABSTRACT

A method and apparatus for enhancing a recording speed in digital holographic image recording is provided, the method including analyzing a target image, generating a plurality of hogels from the target image, and recording the plurality of hogels on a recording medium based on a light modulation scheme, wherein the target image includes a plurality regions, and a size of the plurality of hogels differs based on the plurality of regions of the target image.

### CROSS-REFERENCE TO RELATED APPLICATION

This application claims the priority benefit of Korean Patent Application No. 10-2014-0030339, filed on Mar. 14, 2014, in the Korean Intellectual Property Office, the disclosure of which is incorporated herein by reference.

### BACKGROUND

1. Field of the Invention

Embodiments of the present invention relate to a method and an apparatus for enhancing a recording speed in holographic image recording.

2. Description of the Related Art

In general, a method of recording a hologram in a holographic film may be classified into an analog method and a digital method.

The analog method generates a hologram through interference between a light reflected by irradiating a beam onto an object to be recorded using a coherence light source such as a laser and a reference beam corresponding to a pure laser beam. The digital method generates an interference pattern for each small unit of a hologram element, for example, a hogel. In the digital method, a hologram is generated through interference with a reference beam by condensing an image generated in advance at each hogel.

Limits of an object size or object acquisition may be less of an issue in the digital method than the analog method. However, a quality of the hologram in the digital holographic recording method is highly contingent on a size of a hogel.

In the digital holographic recording method, a recording speed may differ based on a manner of transferring a laser and a film plate. In general, when a continuous wave (CW) laser is used, a stepping method is adopted. However, a relatively slow speed may be experienced due to pauses in the stepping method for each hogel subsequent to transfer of the hogel. A pulsed laser is a light source capable of high-power emission in a nanosecond (ns), and is used to transfer a film in a scanning method. A recording speed in the scanning method may be determined based on a pulse repetition rate (PRR) and a frame rate of a spatial light modulator (SLM).

### SUMMARY

An aspect of the present invention provides a method for reducing a recording time using an optical module described above, and enhancing a recording speed based on an applicable hierarchical hogel.

To this end, a digital holographic printing system configuration that records hogels in differing sizes and a recording method that utilizes the system configuration are provided.

Another aspect of the present invention also provides a digital holographic recording method that efficiently reduces a recording time based on a distribution rate of hogels high in a size hierarchy, and efficiently reduces a speed of generating a hogel image required for recording and a data amount when compared to a method of performing an entire recording using an identical size hogel.

According to an aspect of the present invention, there is provided a digital holographic recording method, the method including analyzing a target image, generating a plurality of hogels from the target image, and recording the plurality of hogels on a recording medium based on a light modulation scheme, wherein the target image comprises a plurality of regions, and a size of the plurality of hogels differs based on the plurality of regions.

The generating of the plurality of hogels from the target image may include generating a plurality of hogels corresponding to each of the plurality of regions based on a spatial correlation of the plurality of regions of the target image.

The generating of the plurality of hogels from the target image may include generating the plurality of hogels to allow a size of a hogel corresponding to a first region of the plurality of regions of the target image to be greater than a size of a hogel corresponding to a second region of the plurality of regions of the target image when a spatial correlation of the first region is greater than a spatial correlation of the second region.

The recording of the plurality of hogels on the recording medium based on the light modulation scheme may include recording the plurality of hogels in a sequence based on the size of the plurality of hogels.

The recording of the plurality of hogels on the recording medium based on the light modulation scheme may include recording the plurality of hogels on the recording medium using a spatial light modulator (SLM).

The recording of the plurality of hogels on the recording medium using the SLM may include recording the plurality of hogels on the recording medium in a hierarchical manner by adjusting a size of a reference beam of the SLM to correspond to the size of the plurality of hogels.

The recording of the plurality of hogels on the recording medium using the SLM may include changing the size of the plurality of hogels to be recorded on the recording medium by changing a position of at least one of a film transfer stage of the SLM and a condenser of the SLM.

The recording of the plurality of hogels on the recording medium using the SLM may include controlling an exposure time by controlling a shutter of the SLM based on the size of the plurality of hogels.

The recording of the plurality of hogels on the recording medium using the SLM may include controlling a time expected to reduce vibration of the recording medium to be different based on the size of the plurality of hogels.

According to an aspect of the present invention, there is provided a digital holographic recording method, the method including analyzing a target image, wherein the target image comprises a plurality of regions, determining a plurality of hogels corresponding to the plurality of regions of the target image, and generating a first hogel group corresponding to a first color channel, wherein sizes of the plurality of hogels to be comprised in the first hogel group are different, determining a plurality of hogels corresponding to the plurality of regions of the target image, and generating a second hogel group corresponding to a second color channel, wherein sizes of the plurality of hogels to be comprised in the second hogel group are different, and recording the first hogel group and the second hogel group on a recording medium based on a light modulation scheme.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a configuration of a digital holographic recording system and a spatial light modulator (SLM) according to related art;

FIG. 2 is a diagram illustrating a correlation between a hogel size and transfer of a film transfer stage according to related art;

FIG. 3 is a diagram illustrating an example of an existing normalized hogel image according to related art;

FIG. 4 is a flowchart illustrating a digital holographic recording method according to an embodiment of the present invention; and

FIG. 5 is a diagram illustrating an example of a hierarchical hogel recording image according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Hereinafter, a digital holographic recording method based on a hierarchical hogel and an apparatus therefor will be described with reference to accompanying drawings.

According to an aspect of the present invention, a hierarchical recording method is applied to enhance efficiency in hologram recording as described in the preceding. In the hologram recording, a resolution of a record result may be determined based on a degree of condensation of a condenser.

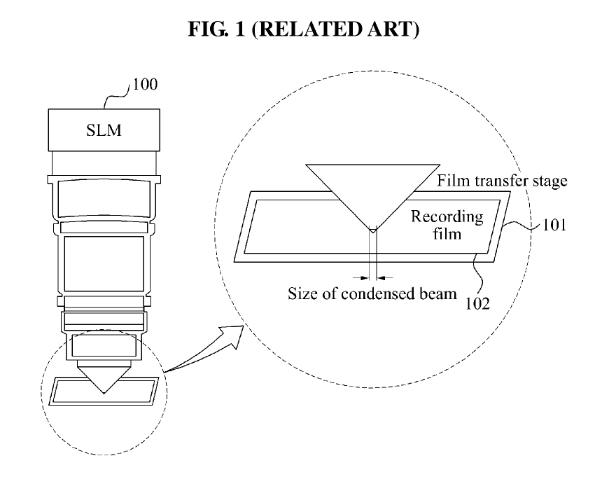

FIG. 1 is a diagram illustrating a configuration of a digital holographic recording system and a spatial light modulator (SLM) 100 according to related art.

A target image for recording to be input in the SLM 100 of FIG. 1 may be output in a form of a condensed beam through a condensing lens, and recorded on a recording medium, for example, a recording film 102.

In this example, the smaller the form of the condensed beam, the higher a resolution of the target image to be recorded on the identical recording film 102. A single target image may be loaded on the SLM 110, and a height of a film transfer stage 101 on which the recording film 102 is disposed may be adjusted to adjust a recording resolution because recording a hogel is performed in a unit of a single pixel.

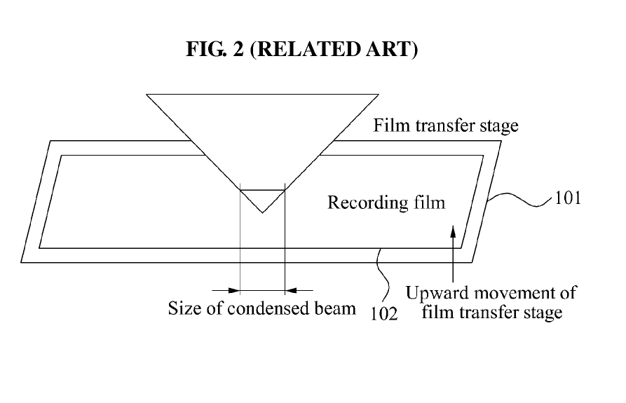

FIG. 2 is a diagram illustrating a correlation between a hogel size and transfer of a film transfer stage according to related art.

As previously described above, the height of the film transfer stage 101 including the recording film 102 may be adjusted to determine a resolution when a target image is recorded. In an existing digital holographic recording method, when a size of a hogel to be recorded is determined, the SLM 100 may load hogels generated in the determined size per piece, and perform recording by transferring the recording film 102 in horizontal and vertical directions by a number of the hogels.

In the existing method, the height of the film transfer stage 101 may remain fixed during the recording. Accordingly, in an existing system, a size of a hogel to generate a single record may be fixed and may not change until the recording is complete.

Due to the fixed height of the film transfer stage 101, the size of the hogel may be identical, and thus maintaining the same complexity, for example, a resolution, of the target image to be recorded at all times irrespective of information of the target image to be recorded, for example, a substantial complexity of content of the target image.

Accordingly, to resolve such an issue, a digital holographic recording method based on hierarchical exposure of a hogel is provided according to an embodiment of the present invention.

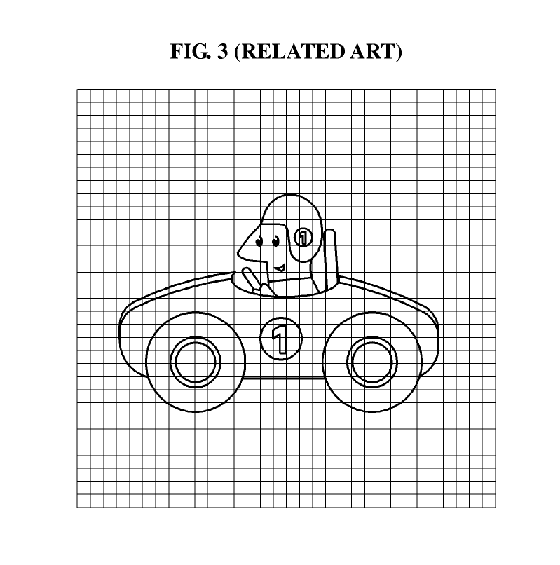

FIG. 3 is a diagram illustrating an example of an existing normalized hogel image according to related art.

Referring to FIG. 3, hogels in an identical size are used to record an image of a vehicle. The image as shown in FIG. 3 may require 1024 times of hogel exposure on a recording medium with respect to “32×32=1024” hogels. In this example, the hogel exposure may need to be performed 1024 times irrespective of a substantial complexity of the image.

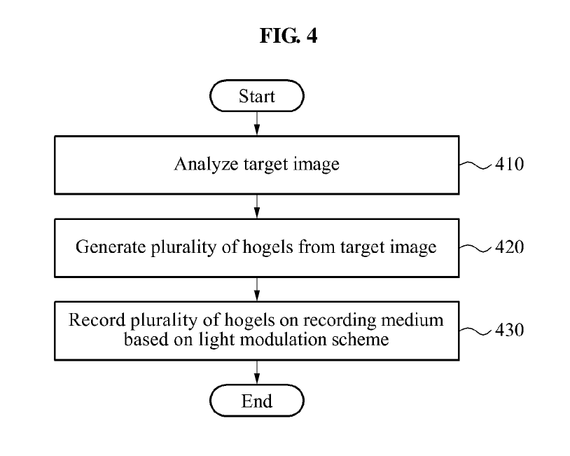

FIG. 4 is a flowchart illustrating a digital holographic recording method according to an embodiment of the present invention.

The digital holographic recording method according to an embodiment of the present invention is a method of recording a hogel generated in an SLM on a recording medium using a condenser of the SLM.

In operation 410, a target image to be recorded may be analyzed. During the analysis of the target image, complexity of a plurality of regions of the target image may be verified. According to an embodiment, the complexity may be verified based on a number of colors or a pattern of the target image. When the target image is analyzed, a spatial correlation of the plurality of regions with adjacent regions may be calculated.

In this example, a spatial correlation of a predetermined region X may be calculated based on a similarity with other regions adjacent to the region X.

In operation 420, a plurality of hogels may be generated from the target image. The plurality of hogels may include a relatively small hogel and a relatively large hogel. A size of the plurality of hogels may be provided in greater than two types.

According to an embodiment, the plurality of hogels may be generated corresponding to each of the plurality of regions using the spatial correlation of the plurality of regions of the target image based on a result of the analysis in operation 410. When a spatial correlation of a first region of the plurality of regions of the target image is greater than a spatial correlation of a second region of the plurality of regions, the plurality of hogels may be generated in a manner in which a size of a hogel corresponding to the first region is greater than a size of a hogel corresponding to the second region.

By way of example, in the hogel generation based on the spatial correlation, a relatively small sized hogel may be generated in a region having a relatively small spatial correlation, for example, a region requiring precise recording, and a relatively large sized hogel may be generated in a region having a relatively great spatial correlation, for example, a background region of the image.

In operation 430, the plurality of generated hogels may be recorded on the recording medium based on a light modulation scheme. According to an embodiment, a hogel corresponding to the target image may be recorded on the recording medium, for example, a recording film.

In this example, the hogels may be recorded on the recording medium in a sequence based on the size of the plurality of generated hogels. In an example, the hogels may be recorded in a sequence from a large size to a small size. In another example, the hogels may be recorded in a sequence from a small size to a large size. In still another example, the hogels may be recorded in a sequence of positions at which the hogels are recorded.

In the hogel recording on the recording medium, the hogels may be recorded using the condenser of the SLM based on the light modulation scheme. According to an embodiment, in the recording based on the light modulation scheme, the plurality of hogels may be recorded on the recording medium by adjusting a size of a reference beam of the SLM to be proportional to the size of the plurality of generated hogels.

A height of a film transfer stage of the SLM may be adjusted to adjust the size of the reference beam, or a position of the condenser of the SLM or a distance between the recording medium, and the hogel may be adjusted to change the size of the hogels to be recorded on the recording medium. Also, the size of the hogels to be determined based on transfer of any one of the film transfer stage and the condenser may determine a recording resolution.

In the hogel recording on the recording medium in operation 430, an exposure time may be controlled by controlling a shutter of the SLM based on the size of the plurality of hogels. According to an embodiment, the exposure time may be determined differently based on the size of the hogels because an optimum exposure time varies based on the size of the hogels.

Also, a time expected to reduce vibration of the recording medium may be controlled differently based on the size of the hogels because the time for residual vibration to be diminished subsequent to transferring of the recording medium may differ based on the size of the hogels.

According to an embodiment, the condenser of the SLM may include various color channels, and generate a plurality of independent hogels by analyzing the target image for each of the color channels.

The target image may be analyzed for each of the color channels, for example, a first color channel. A first hogel group corresponding to the first color channel may be generated by determining a hogel corresponding to each of a plurality of regions of the target image. In this example, a size of a plurality of hogels included in the first hogel group may be generated in various sizes rather than in an identical size.

In a similar manner, a second hogel group corresponding to a second color channel may be generated by determining a hogel corresponding to each of the plurality of regions of the same target image. In this example, a size of a plurality of hogels included in the second hogel group may be generated in various sizes rather than in an identical size.

As previously described, it is to be understood that the present exemplary embodiment is not limited to the aforementioned two types of color channels, and may be applied through being expanded to more than two types, for example, including a third color channel, a fourth color channel, and the like.

The first hogel group and the second hogel group generated as such may be recorded on the recording medium by the SLM based on the light modulation scheme. In this example, the first hogel group and the second hogel group may be recorded in an identical hierarchy or recorded in a sequence based on the size of the hogels.

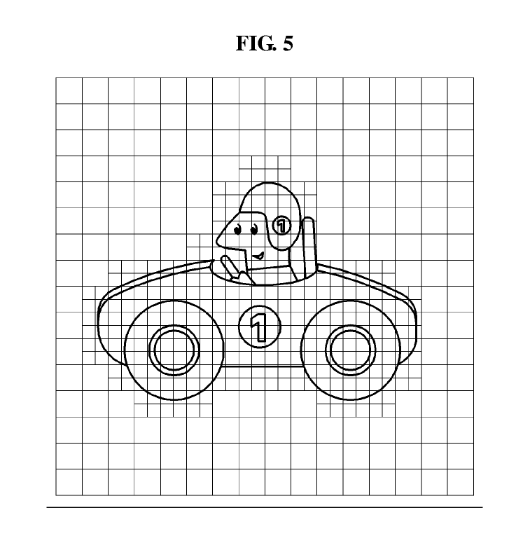

FIG. 5 is a diagram illustrating an example of a hierarchical hogel recording image according to an embodiment of the present invention.

Referring to FIG. 5, approximately one-half the number of small hogels in FIG. 3 are required, for example, a total of 544 hogels including 160 large hogels and 384 small hogels, in an example as shown in FIG. 5.

Aside from two types of hierarchy provided in FIG. 5, when the two hierarchy types are extended to a plurality of hierarchy types, a number of hogels required for recording may be expected to be significantly reduced when compared to using small hogels in a single hierarchy type.

Also, a number of instances to perform exposure of a hogel to be recorded may decrease to considerably reduce a time required to generate a stereogram, thus providing beneficial effects in developing a real-time or low-complexity holographic recording system.

When a target image in the example of FIG. 5 includes various colors, an independent form of a hogel may be generated for each of a plurality of color channels. For example, a hierarchical image in differing forms may be generated for each of the plurality of color channels, and when recording is performed on all of the plurality of color channels, recording corresponding to the target image may be complete.

According to an aspect of the present exemplary embodiment, there is provided a digital holographic recording method that efficiently reduces a recording time based on a distribution rate of hogels high in a size hierarchy, and efficiently reduces a speed of generating a hogel image required for recording and a data amount when compared to a to recording method using hogels in an identical size.

The units described herein may be implemented using hardware components, software components, or a combination thereof. For example, a processing device may be implemented using one or more general-purpose or special purpose computers, such as, for example, a processor, a controller and an arithmetic logic unit (ALU), a digital signal processor, a microcomputer, a field programmable array (FPA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

According to an aspect of the present exemplary embodiment, there is provided a digital holographic recording method that efficiently reduces a recording time based on a to distribution rate of hogels high in a size hierarchy, and efficiently reduces a speed of generating a hogel image required for recording and a data amount when compared to a method of performing an entire recording using an identical size hogel.

The above-described example embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. The non-transitory computer-readable media may also be a distributed network, so that the program instructions are stored and executed in a distributed fashion. The program instructions may be executed by one or more processors. The non-transitory computer-readable media may also be embodied in at least one application specific integrated circuit (ASIC) or Field Programmable Gate Array (FPGA), which executes (processes like a processor) program instructions. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

Although example embodiments have been shown and described, it would be appreciated by those skilled in the art that changes may be made in these example embodiments without departing from the principles and spirit of the disclosure, the scope of which is defined by the claims and their equivalents. For example, proper results can be achieved although the described techniques are performed in an order different from the methods described or, and/or described system, architecture, device, circuit components such as the methods described in combination with or in combination with other types or other components or substituted or replaced by equivalents. Therefore, other implementations, other embodiments, and equivalents to appended claims will be described later within the scope of the appended claims.

What is claimed is:

1. A digital holographic recording method, the method comprising:
analyzing a target image;
generating a plurality of hogels from the target image; and
recording the plurality of hogels on a recording medium based on a light modulation scheme,
wherein the target image comprises a plurality of regions, and
a size of the plurality of hogels differs based on the plurality of regions.

2. The method of claim 1, wherein the generating of the plurality of hogels from the target image comprises:
generating a plurality of hogels corresponding to each of the plurality of regions based on a spatial correlation of the plurality of regions of the target image.

3. The method of claim 1, wherein the generating of the plurality of hogels from the target image comprises:
generating the plurality of hogels to allow a size of a hogel corresponding to a first region of the plurality of regions of the target image to be greater than a size of a hogel corresponding to a second region of the plurality of regions of the target image when a spatial correlation of the first region is greater than a spatial correlation of the second region.

4. The method of claim 1, wherein the recording of the plurality of hogels on the recording medium based on the light modulation scheme comprises:
recording the plurality of hogels in a sequence based on the size of the plurality of hogels.

5. The method of claim 1, wherein the recording of the plurality of hogels on the recording medium based on the light modulation scheme comprises:
recording the plurality of hogels on the recording medium using a spatial light modulator (SLM).

6. The method of claim 5, wherein the recording of the plurality of hogels on the recording medium using the SLM comprises:
recording the plurality of hogels on the recording medium in a hierarchical manner by adjusting a size of a reference beam of the SLM to correspond to the size of the plurality of hogels.

7. The method of claim 5, wherein the recording of the plurality of hogels on the recording medium using the SLM comprises:
changing the size of the plurality of hogels to be recorded on the recording medium by changing a position of at least one of a film transfer stage of the SLM and a condenser of the SLM.

8. The method of claim 5, wherein the recording of the plurality of hogels on the recording medium using the SLM comprises:
controlling an exposure time by controlling a shutter of the SLM based on the size of the plurality of hogels.

9. The method of claim 5, wherein the recording of the plurality of hogels on the recording medium using the SLM comprises:
controlling a time expected to reduce vibration of the recording medium to be different based on the size of the plurality of hogels.

10. A digital holographic recording method, the method comprising:
analyzing a target image, wherein the target image comprises a plurality of regions;
determining a plurality of hogels corresponding to the plurality of regions of the target image, and generating a first hogel group corresponding to a first color channel, wherein sizes of the plurality of hogels to be comprised in the first hogel group are different;
determining a plurality of hogels corresponding to the plurality of regions of the target image, and generating a second hogel group corresponding to a second color channel, wherein sizes of the plurality of hogels to be comprised in the second hogel group are different; and
recording the first hogel group and the second hogel group on a recording medium based on a light modulation scheme.

11. The method of claim 10, wherein the first hogel group and the second hogel group are independent of each other.

12. The method of claim 10, wherein the generating of the first hogel group and the generating of the second hogel group comprise:
generating a plurality of hogels corresponding to each of the plurality of regions based on a spatial correlation of the plurality of regions of the target image.

13. The method of claim 12, wherein the generating of the plurality of hogels corresponding to each of the plurality of regions based on the spatial correlation of the plurality of regions of the target image comprises:
generating the plurality of hogels to allow a size of a hogel corresponding to a first region of the plurality of regions of the target image to be greater than a size of a hogel corresponding to a second region of the plurality of regions of the target image when a spatial correlation of the first region is greater than a spatial correlation of the second region.
